(19) United States
(12) Patent Application Publication
(10) Pub. No.: US 2010/0173794 A1
(43) Pub. Date: Jul. 8, 2010

(54) DEVICE FOR AMPLIFICATION AND DETECTION OF NUCLEIC ACIDS

(75) Inventors: Erik Robbert Vossenaar, Eindhoven (NL); Derk Jan Wilfred Klunder, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/445,787

(22) PCT Filed: Oct. 11, 2007
(86) PCT No.: PCT/IB07/54141

§ 371 Date: Apr. 16, 2009

(30) Foreign Application Priority Data
Oct. 17, 2006 (EP) 06122465.5

(51) Int. Cl. C40B 30/04; C40B 40/06

(52) U.S. Cl. 506/9; 506/16

(57) ABSTRACT

A device is provided which is suitable for use in the amplification and detection of nucleic acids. The device comprises a simple tube comprising a compartment (3) that is preferably open at the top such that its content flows out when the tube (1) is turned upside down. The tube further comprises a cap (2) which comprises a microarray of nucleic acids to which amplified sample DNA may hybridize.

### FIELD OF THE INVENTION

The invention relates to a device and a method for amplifying and detecting nucleic acid fragments, especially by hybridization.

### BACKGROUND TO THE INVENTION

PCR (polymerase chain reaction) is a method to amplify specific nucleic acid fragments. It is often used in research and for diagnosis of various diseases, including many infectious diseases. Detection of amplified PCR products may be done by hybridization to immobilized complementary nucleic acid sequences. By immobilizing the specific complementary sequences (so-called capture probes) in a defined pattern, multiple nucleotide sequences can be detected simultaneously. Such a patterned array of capture probes is often referred to as micro-array. Nucleic sequences hybridized to the micro array can be detected by optical means, e.g. by fluorescence.

WO-A-01/45843 discloses a system for performing hybridization assays that comprises a cartridge for housing a flow-through device. The flow through device has an array of microchannel passages. The cartridge may include an observation window. Although this system may be functional in a specialized laborotary environment, it does not fulfill the need for a simply operated device that may be operated at a point of care.

WO-A-00/12675 discloses a self-contained device which is described to be easily operated and which is devoid of contamination. The idea described provides for the rapid and accurate detection of amplified nucleic acids using a self-contained device. The device integrates nucleic acid extraction, specific target amplification and detection into a single device, permitting rapid and accurate nucleic acid sequence detection. The self contained device comprises a first hollow cylinder with a single closed end and a plurality of chambers therein, a second hollow elongated cylinder positioned contiguously inside the first cylinder capable of relative rotation. Sample is introduced in the first cylinder for extraction. The extracted nucleic acids is bound to a solid phase, and therefore not eluted from the solid phase by the addition of wash buffer. Amplification and labeling takes place in the same cylinder. Finally, the labeled, amplified product is reacted with microparticles conjugated with receptor specific ligands for the detection of the target sequence.

It is an object of the invention to provide an alternative simple system for amplifying and detecting nucleic acids.

### SUMMARY OF THE INVENTION

The invention therefore relates to a device for amplification and detection of nucleic acids, comprising a tube (1), which comprises at least one compartment (3) comprising reaction composition, and the tube comprising a cap (2) wherein the cap comprises a microarray of nucleic acids on its inside.

The invention further relates to a method for detecting real time hybridization of nucleic acids to a capture probe, which comprises the steps of:

a) Administering a sample comprising PCR mastermix, appropriate PCR primers and template DNA to a bottom compartment of the device according to the invention,

b) administering hybridization buffer to compartment (3)

c) closing the device with the cap comprising a microarray of nucleic acids (capture probes) on its inside

d) carrying out a PCR reaction for amplification of template DNA

e) twisting the device such that the contents of compartment (3) flow out of the compartment

f) optionally twisting the device repeatedly to ensure mixing of its contents with the contents of the device

g) hybridization of the amplified template DNA with the capture probes

h) detecting the hybridized amplified template DNA.

In a further instance the invention relates to a system for amplification and detection of nucleic acids, comprising at least one, preferably a multitude of devices as described above.

### DESCRIPTION OF THE FIGURES

FIG. 1 shows a device according to the invention.

FIG. 2 shows a system according to the invention.

FIG. 3 illustrates the method according to the invention.

### DETAILED DESCRIPTION

### Definitions

Template DNA is DNA that is present in a sample and of which the presence is to be detected.

PCR mastermix is a concentrated mix of PCR reaction components. Generally such a mix comprises a composition selected from the group comprising polymerase enzyme, buffer, nucleotides or a combination thereof. Microarray is defined as a set of miniaturized chemical reaction areas that are used to test nucleotide fragments, preferably DNA fragments.

The tube comprises a compartment (3) that comprises reagents that may be mixed with components present in the bottom compartment of tube (1) at a specific stage in the reaction, preferably after amplification of any target sequence present in a sample in the bottom of tube (1).

The at least one compartment (3) is preferably filled with reaction composition which is most preferred hybridization buffer in case of PCR reactions being carried out.

The compartment (3) preferably comprises an opening at the top side. In this way, the compartment may be manipulated such that its contents are released into the tube (1). Such manipulation may e.g. be by turning the device/tube 180 degrees.

Alternatively the compartment (3) is made of a specific material which may be made permeable or may be ruptured by a specific trigger. Such trigger may be a temperature change, the application of light of a specific wavelength or a chemical reaction that is caused to take place in the tube (1). Most preferred the compartment (3) has an opening at its top side as specified above.

The device according to the invention is preferably integrated into a system comprising a heating element (4), a reader (5) and a transparent bottom plate (6).

Such a system for amplification and detection of nucleic acids, preferably comprises at least one, more preferably a multitude of devices according to the invention.

For carrying out a PCR reaction the system preferably comprises a heating element (4), and a reader (5).

The system preferably further comprises a turning element that serves to rotate the device or devices.

Preferred readers include CCD camera's.

To facilitate the detection, the system most preferably comprises a transparent bottom plate.

In another aspect the invention relates to a method for detecting real time hybridization of nucleic acids to a capture probe, which comprises the steps of:

a) Administering a sample comprising PCR mastermix, appropriate PCR primers and template nucleic acid, preferably DNA to a bottom compartment of the device as described above,

b) administering hybridization buffer to compartment (3)

c) closing the device with the cap comprising a microarray of nucleic acids (capture probes) on its inside

d) carrying out a PCR reaction for amplification of template nucleic acid

e) twisting the device such that the contents of compartment (3) flow out of the compartment

f) optionally twisting the device repeatedly to ensure mixing of its contents with the contents of the device

g) hybridizing the amplified template nucleic acid with the capture probes

h) detecting the hybridized amplified template nucleic acid.

In this method detection is preferably carried out using a scanning reader, most preferred a CCD camera.

The invention is illustrated by a first embodiment as described below.

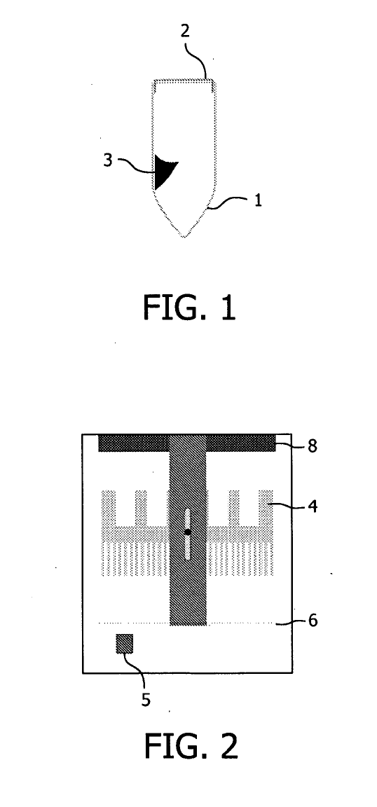

FIG. 1 shows a schematic picture of a reaction tube. A sample, comprising PCR mastermix, appropriate (labelled) PCR primers and template DNA is administered to the bottom of the tube (1). Hybridization buffer is administered to the open fluid compartment (3) inside of the tube (1). The tube is capped with a cap (2) that comprises a microarray of nucleic acids on its inside.

The tube (1) is put into an integrated reader device (FIG. 2) which is herein referred to as the system (8). This system comprises of a movable thermoblock capable of (rapid) thermocycling (heating element 4), a heated top lid and a transparent bottom plate (6). Below the bottom plate a confocal optical reader (5) is positioned. The heating element may be used for temperature regulation in thermocycling, isothermal amplification or for sample heating during hybridization.

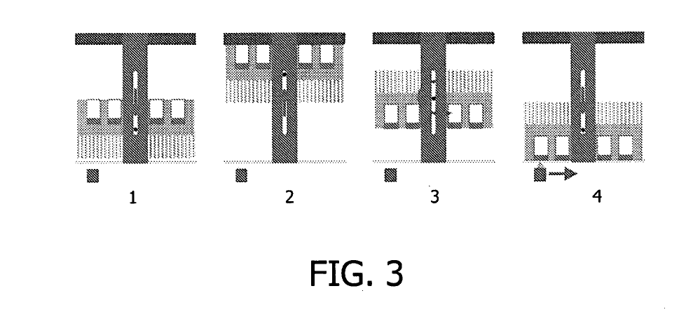

When a sample is to be analysed, it is administered to the tube as described above and then put into the thermoblock (4) (FIG. 3.1). This figure shows an example of a thermoblock capable of holding multiple tubes. A device for a single tube is also feasible. The heating block (4) with the tubes is moved upward to ensure that the caps of the tubes are compressed to a heated lid (3.2). This lid it kept at a constant temperature slightly above 100° C. to prevent sample evaporation during PCR thermocycling. After thermocycling is complete, the thermoblock is moved down and twisted 180° (3.3). This causes the fluid to flow to the top of the tubes and the hybridization buffer to flow out of its compartment (3). Optionally, the block may be twisted repeatedly to ensure proper mixing of PCR fluid and hybridization buffer. Optionally, the block may be moved upright and up again for a 95° C. denaturing step. When the tubes are upside down, the amplified PCR products are allowed to hybridize to the capture probes on the micro array. The block is moved down to a transparent plate. Below this plate is a confocal reader capable of detecting fluorescence. Because the reader is confocal, the measurement (detection and excitation) volume is reduced substantially to typically a few micrometers away from the microarray surface, and thus the reader has enhanced surface specificity. As a result of the enhanced surface specificity, hybridization can be measured in real-time since no washing or removal of fluids is needed. This is illustrated in FIG. 3.4. The reader can be a scanning reader.

As an alternative method for enhancing the surface specificity, one can use evanescent excitation methods, where an evanescent wave is excited at the surface of the substrate and excites surface bound fluorophores. In this context the surface of the cap, positioned at the inner side of the cap, is the substrate.

As a first method one can use total internal reflection (TIR) at the substrate/fluid interface, which results in measurement (excitation) volumes within 100-500 nm of the array surface. TIR however prefers the use of a glass prism connected to the substrate or the use of a substrate with a wedge shape to enable the coupling of excitation light with angles above the critical angle of the substrate-fluid interface into the substrate.

As a second preferred method one may cover the substrate with a non-transparent composition such as a metal and pattern the substrate with [an array of] apertures with at least one dimension in the plane parallel to the substrate-fluid interface below the diffraction limit of light in the fluid. As an example, one can pattern the substrate with wire grids that have one in-plane dimension above and the other dimension below the diffraction limit of the light in the fluid. This results in excitation volumes within 50 nm (typically 20-30 nm) of the array surface. Advantage of this method over the first method [for evanescent excitation] is that it is simpler—there is no need for a prism or wedge shaped surface and that there are no special requirements for the angle of incidence and shape of the excitation spot and one can use a simple CCD camera for imaging the fluorescence—and enables substantially smaller excitation volumes.

In the embodiment where the substrate is patterned with a wire grid, the array of nucleotides can ideally be positioned in the openings of the wire grid.

For further detection techniques reference is for example made to international application IB2005/053168 which is incorporated by reference.

1. A device for amplification and detection of nucleic acids, comprising a tube (1), which comprises at least one compartment (3) comprising reaction composition, and the tube comprising a cap (2) wherein the cap comprises a microarray of nucleic acids on its inside.

2. Device according to claim 1 wherein the at least one compartment (3) is filled with reaction composition which is hybridization buffer.

3. Device according to claim 1 wherein the compartment (3) may be manipulated such that its contents are released into the tube (1).

4. Device according to claim 1 wherein the compartment (3) comprises an opening at its top side.

5. Device according to claim 1 which is integrated into a system comprising a heating element (4), a reader (5) and a transparent bottom plate (6).

6. System for amplification and detection of nucleic acids, comprising at least one, preferably a multitude of devices according to claim 1.

7. System according to claim 6 further comprising, a heating element (4), and a reader (5).

8. System according to claim 6, further comprising a turning element that serves to rotate the device or devices.

9. System according to claim 6, wherein the reader is a confocal reader.

10. System according to claim 6, comprising a surface of the cap as substrate, wherein the substrate is wedge shaped in order to enable excitation of fluorophores at the microarray surface.

11. System according to claim 6, comprising a surface of the cap as substrate wherein the substrate is attached to a prism in order to enable excitation of fluorophores at the array surface.

12. System according to claim 6, comprising a surface of the cap as substrate, where the substrate is covered at the interface facing the fluid with a patterned composition in order to enable evanescent excitation at fluorophores at the array surface.

13. System according to claim 6 further comprising a transparent bottom plate.

14. Method for detecting real time hybridization of nucleic acids to a capture probe, which comprises the steps of:
a) Administering a sample comprising PCR mastermix, appropriate PCR primers and template nucleic acids, preferably DNA, to a bottom compartment of the device according to claim 1,
b) administering hybridization buffer to compartment (3)
c) closing the device with the cap comprising a microarray of nucleic acids, called capture probes, on its inside
d) carrying out a PCR reaction for amplification of template nucleic acid
e) twisting the device such that the contents of compartment (3) flow out of the compartment
f) optionally twisting the device repeatedly to ensure mixing of its contents with the contents of the device
g) hybridizing the amplified template nucleic acid with the capture probes
h) detecting the hybridized amplified template nucleic acid.

15. Method according to claim 14 wherein detection is carried out using a scanning reader.

16. Method according to claim 14 for use in the detection of infectious diseases.
